(19) United States
(12) Patent Application Publication
(10) Pub. No.: US 2010/0022925 A1
(43) Pub. Date: Jan. 28, 2010

(54) Thigh support with vibratory device for improved blood circulation

(76) Inventor: Sergey Anikin, Atherton, CA (US)

Correspondence Address: Sergey Anikin, 87 Walnut Avenue, Atherton, CA, 94027, US

(21) Appl. No.: 12/220,726

(22) Filed: Jul. 28, 2008

(51) Int. Cl. A61H 1/00

(52) U.S. Cl. 601/55; 601/46; 601/49

(57) ABSTRACT

A thigh support that consists of a resilient, e.g., a self-inflatable, part for supporting the thigh of a vehicle driver and a vibration-transmission member for transmitting vibrations to the driver's leg in order to improve blood circulation in the leg of the driver during long hours of driving. The thigh support may be of a type intended for shortening brake-activation time and combining brake-activation shortening time function with the function of improving blood circulation in the driver's leg due to transmission of vibration to the leg from the vibratory unit of the thigh support. The vibration-transmission member comprises a sealed cartridge in the form of a rubber casing filled with liquid and containing a sealed and encapsulated vibration motor that transmits vibration through the liquid.

### FIELD OF THE INDUSTRY

The invention relates to ergonomics, in particular to the ergonomics of a seated person such as vehicle driver as a mechanical system. Specifically, the invention relates to a thigh support of the aforementioned type that is provided with a built-in vibratory device for improving circulation of blood in the leg of a driver. More specifically, the invention concerns a brake-activation time-shortening thigh support consisting of a resilient pad and a vibration transmission device which is placed between the aforementioned thigh support and the thigh of a seated person, e.g., a driver who has to be immobile in a driver's seat for a long period of time during long-way driving and whose blood circulation can be improved by the aforementioned vibratory device.

### BACKGROUND OF THE INVENTION AND DESCRIPTION OF THE PRIOR ART

Sitting is the most frequent body posture: we sit at work, at school, in the car, on the bus, on the train, in an airplane, and so on. Those who are wheelchair-bound are in seated positions for an entire day.

A seat should take the weight off one's feet in order to lessen stress on the legs, and the seat should provide some postural stability while one works or relaxes. One should also be able to relax muscles that are at rest.

Seat height should not be so high that the occupant's legs are left dangling, thereby causing pressure on the soft tissues under the thighs. This pressure can interfere with the return of blood from the lower limbs, which may cause tingling and numbness in the thighs due to pressure on blood vessels and nerves.

At the same time, there exists an opinion that prolonged travel in a seated position can cause venous stasis. Venous stasis refers to loss of proper function of the veins in the legs that would normally carry blood back to the heart.

N. S. Lee, et al, showed in their “Review of Selected Literature Related to Seating Discomfort” submitted in 1990 to Ikeda Engineering Corporation, Mich., USA that in terms of ml/min/100 ml of body segment, blood flow in the leg of a person (4 ml/min/100 ml) in a seated position is much lower than, e.g., in the arm (10 ml/min/100 ml). This means that the legs of a seated person are to a greater extent subject to tingling and numbness in the thighs caused by pressure on blood vessels and nerves.

The aforementioned abnormalities of blood circulation are caused by areas on the chair that cause increased pressure on the thighs of a person seated on a chair or on a similar support. In the majority of cases, such areas are the edges of a seat.

Attempts have been made to improve a seat support for redistribution of pressure on the buttocks. For example, Pain Reliever Co., KS, distributes the G-Seat Gel Cushion [hereinafter referred to as the “G-Seat Gel Cushion”] for improved blood circulation. (See Http://www.autosportcatalog.com/index.cfm/fa/p/pid/2168/cid/57/sc/2737)

The G-Seat Gel Cushion uses viscoelastic gel and a functional design to disperse pressure and to improve the level of comfort on whatever type of support one sits. The G-Seat Gel Cushion features a center relief groove that eliminates soft-tissue compression and suspends the tailbone (coccyx), which eliminates direct pressure on the spine.

Pressure redistribution occurs because the gel that fills the seat takes the form of the conforming body part, i.e., the buttocks. In other words, pressure on the buttock and thigh surfaces that is in contact with the G-seat Gel Cushion is redistributed in accordance with Pascal's Law, i.e., in a normal direction and uniformly at all points of contact. However, since the G-seat Gel Cushion is substantially flat, the problem is solved only partially. In other words, localized areas of increased pressure will still exist on the edges of the G-seat Gel Cushion.

German Patent Publication DE10200500243 published on Jul. 27, 2006 (inventor A. Wunder, et al) discloses a chair with a seat that has a backrest, cushion, and adjustable thigh support. The thigh support comprises a U-shaped unit that is arranged across the chair and under the thighs of the occupant and is adjustable opposite to the cushion. A gap forms between the cushion and the U-shaped unit during adjustment of the U-shaped unit opposite to the cushion. An adjustment device can cover the gap, and the cushion is composed of a foam material. The above-described thigh support does not solve the aforementioned problem of localized pressure on the thigh surfaces at the edge of the transverse thigh support and, instead, only shifts the position of the edge.

A number of patents, such as U.S. Pat. No. 4,636,002 (published on Jan. 13, 1987, inventor T. Genjiro); U.S. Pat. No. 4,712,834 (published on Dec. 15, 1987, inventor J. Warrick, et al); and U.S. Pat. No. 4,838,509 (published on Jun. 13, 1989, inventor J. Klink, et al) disclose car seats with adjustable features that include thigh supports. However, all of these devices are permanently built into the structure of the seat, operate with the use of complicated and expensive mechanisms, and change only vertical and angular positions of the transverse thigh support.

U.S. Pat. No. 5,083,551 issued in 1992 to K. Addison, Jr. discloses a method and apparatus for providing improved blood circulation to a person seated in a wheelchair or a stationary chair used by handicapped persons or by those who must remain inactive in a seated position for extended periods of time. The apparatus imparts an undulating, wave-like motion to the flexible seat portion of the chair, which stimulates blood circulation in the lower extremities and prevents development of ischaemic or decubitus ulcers by providing changing points of pressure on the buttocks and thighs of the seated individual. The apparatus is connected to a wheelchair or chair, and is powered by a storage battery mounted thereon.

U.S. Pat. No. 7,093,898 issued in 2006 to L. De Guevara discloses a portable air-pressure-applying assembly for seats. Proposed in this patent is an air-pressure-applying assembly having an occupant-holding portion for selectively applying the desired pressure to the body of the seated occupant. This assembly includes an air-bag assembly, an air-pressure source, an inlet-conduit assembly, an exhaust valve assembly, and a control assembly. The air-bag assembly is removably attached to the seat occupant-holding portion. The inlet-conduit assembly is in fluid communication with the air-pressure source at one end and at another source with the air-bag assembly. The exhaust valve assembly is in fluid communication with the inlet conduit assembly at one end and has an air-outlet at the other end. A control assembly is linked to the air pressure source and to the exhaust valve assembly. The control assembly is configured so as to selectively signal the air-pressure source to inflate the air bag assembly in order to apply the desired pressure to the body of the seated occupant and to selectively signal the exhaust valve assembly to release air from the air-bag assembly.

In order to solve the above problem, the inventor herein has developed a pad for supporting the thigh of a person sitting on a seat in a position that alleviates pressure applied to the lower surface of the thigh and thus for improving blood circulation through the leg without numbness or similar phenomena associated with long-time sitting. This pad is disclosed in U.S. Pat. No. 7,255,396 issued to the applicant of the present patent application in 2007. The pad is made in the form of a soft, deformable body filled, e.g., with silicone gel. The pad has a flat rectangular bottom surface and curvilinear lateral sides. In the plane perpendicular to the bottom, the pad has a triangular cross-section with heights of the triangles gradually reduced from one end face of the pad to the opposite end face of the pad so that the ridge that connects the apexes of the triangular cross-sections from one end face to the other is inclined with respect to the flat bottom.

In further development of the above idea, the applicant of the present patent application invented a self-inflatable thigh support, which is disclosed in pending U.S. patent application Ser. No. 12/011,316 filed Jan. 26, 2008. The thigh support is made in the form of an elongated body of a triangular cross-section that consists of an air-proof inner casing made from a non-stretchable flexible material and a squeezable foam plastic that fills the interior of the casing. The casing is provided with a valve that can be opened for squeezing the pad to a compressed state and then closed for preserving the pad in a compressed state, which is convenient for storage and transportation. To use the pad, the valve is opened, the squeezed foam plastic expands, and then the valve is closed, whereby the pad is maintained in a predetermined shape and with a predetermined rigidity. An advantage of this thigh support is that it can be deflated and squeezed to small dimensions convenient for storage and transportation. Another advantage is that rigidity of the support in the inflated state can be adjusted by releasing a portion of air trapped in the fully inflated thigh support.

It has been stated in the aforementioned pending patent application that use of a thigh support of the aforementioned type alleviates pressure applied to the lower surface of the thigh and thus improves blood circulation through the leg without numbness or similar phenomena associated with long-time sitting. However, this statement is qualitative because the degree to which use of such support can improve blood circulation in the legs of a seated person has not been measured, nor have geometry, rigidity, and elasticity of the thigh support been determined to the extent of providing the most optimal blood circulation.

In his earlier U.S. patent application Ser. No. 12/151,547 filed May 8, 2008, the applicant discloses a method of finding a thigh support for the most optimal blood circulation in the feet of a seated person consisting of measuring a blood-circulation parameter such as velocity of blood flow through the lower extremities of a seated person under different sitting conditions, including those with and without the use of any thigh-supporting means. It has been proven that in the latter case, the measured blood-circulating parameter was much better than in a person sitting without the use of the thigh-supporting means. Velocity of blood flow through the lower extremities of the person sitting in the aforementioned sitting device was measured by determining Doppler shift in the frequency of the returning ultrasound waves.

However, all methods and devices described above are characterized by a passive action and are not sufficiently effective for reducing risk of thrombosis in a person who is immobile for a substantial period of time.

Active methods and devices for improving blood circulation in a person who is lying or sitting or in a person who is immobile for a significant period of time are also known in the art.

For example, U.S. Pat. No. 3,853,121 issued in 1974 to B. Mizrachy, et al., describes a method for reducing the risk of incurring venous thrombosis in operative and postoperative patients. Vibration, massage, or both, are imparted to the legs of a patient during and after surgery. Vibration and massage aid muscular activity in the legs, which, in turn, stimulate blood vessels, thereby reducing the probability of blood-clot formation therein.

U.S. Patent Application Publication No. 20040183343 published in 2004 (inventor P. Probst) discloses a bicycle saddle/seat with an electronically powered vibrating/oscillating mechanism comprised of a digital programmable seat control bar, a power source to drive the vibratory/oscillating motor mechanism, and a vibratory/oscillating tube integrated within a concave integrated molded tube tunnel affixed to or running within the underside plastic seat for the length of the bicycle seat. The entire seat vibrates or oscillates upon rider activation of the tube vibrating/oscillating mechanism within and by virtue of its affixation/integration within the plastic underside of the seat having contact at points appropriate with the metal rod infrastructure on the underside.

U.S. Patent Application Publication No. 20050137506 published in 2005 (inventor l. Chow) discloses an inflatable bag that exerts a force during inflation and is composed of an electrical air pump disposed in fluid communication with the bag for supplying an atmospheric air medium to inflate the bag, a solenoid valve disposed in fluid communication with the inflatable bag for discharging the atmospheric air medium to deflate the bag, and a timing control circuit coupled to the pump and to the solenoid valve for cyclically inflating and deflating the bag. The control circuit includes a dual integrated circuit timer operable with an external resistor-capacitor timer control to provide cyclical inflation and deflation of the bag. Duration of the cycle is adjusted with a variable resistor coupled to the dual timer. The apparatus can be integrated into a seat.

Most pains, such as back pains, and numbness of lower limbs can be associated with fatigued muscles and restricted blood circulation and may be caused by prolonged sitting. These pains can be reduced by an active exercise routine or by stretching and relaxing the muscles to improve blood circulation. However, performing such active exercises may not be possible in some working environments or when traveling in a confined space, such as in an automobile.

Devices for passively exercising a portion of the human body, particularly, the lumbar region of the spine, are well known in the art. For example, U.S. Pat. No. 4,981,131 issued in to R. Hazard in 1991 teaches an apparatus for applying force to the lumbar region of the spine using an inflatable bladder that is pressurized and depressurized to effect a change in a degree of lordosis. Pressurization and depressurization of the bladder is achieved with an air compressor pump and a plurality of solenoid valves and timers. A pressure regulator installed intermediate an air supply source and the air compressor pump is included for controlling the pressure in the bladder at maximum inflation and for limiting such maximum pressure. The pressure regulator can be either a precision variable-pressure release valve type of regulator or a combination of solenoid valves and timers.

U.S. Pat. No. 5,637,076 to R. Hazard et al., in 1997 teaches an improved apparatus incorporating a transducer element for monitoring and measuring forces produced by such inflatable bladder and a logic system responsive to the output of the transducer for controlling application of force. A single valve is used for the release of pressure to the atmosphere in order to depressurize such bladder.

Both U.S. Pat. Nos. 4,981,131 and 5,637,076 teach such an apparatus as either a portable device or one that can be integrated into a chair or a vehicle seat.

The primary disadvantages of such devices are the complexity and added expense of the air supply and control arrangement to pressurize and depressurize the bladder and to control the forces applied to the human body. An additional disadvantage of such prior art devices is the requirement to provide an air supply source.

U.S. Pat. No. 4,938,528 issued to G. Scott in 1990 teaches a seat assembly with an inflatable bladder for adjustable seat support having an air delivery system for both pressurizing and depressurizing the bladder by using a one-directional motor-driven pump and a plurality of valves selectively operable to communicate the pump outlet with the bladder and the pump inlet with the atmosphere for inflating the bladder and also selectively operable to communicate the pump inlet with the bladder and the pump outlet with the atmosphere in order to deflate the bladder. This air delivery system also uses one or more spring-biased check valves.

The air supply and control arrangement reduces complexity and expense of the arrangement taught by U.S. Pat. Nos. 4,981,131 and 5,637,076 but requires manual control of pressurizing and depressurizing the bladder, therefore rendering it impractical for exercising of the human body.

U.S. Pat. No. 5,462,515 issued in 1995 to C. Tseng discloses a multifunctional automatic circular massaging device suitable to be disposed in both back cushion and seat cushion of a seat. The device includes at least a pair of motors respectively disposed in a pair of housings to rotatively drive cams for creating a vibrating massaging effect, a soft pad formed with two lateral recesses for receiving the housings, a heating coil sandwiched between two layers of unwoven fabrics, a surface layer covering the soft pad, and a controlling box connected to the motors and an external power source. A setting key of the controlling box is used to vary and fix the time interval for each of the eight stages. A heating key is used to activate the heating coil for creating heating effect.

Also known are many other devices having vibratory action for improvement of blood circulation in an immobile person. However, none of these devices fulfills the function of shortening brake-activation time for the driver of a vehicle.

On the other hand, the inventor herein has invented a system to determine the shortest time needed for a driver to switch a foot from the accelerator pedal to the brake pedal in case of emergency and to push on the brake pedal. This system is described in U.S. Pat. No. 7,373,810 issued in 2008 and is based on the use of a special thigh-supporting pad disclosed in U.S. Pat. No. 7,255,396 issued in 2007 to the same applicant or on the use of a self-inflatable under-thigh support disclosed in pending U.S. patent application Ser. No. 12/011,316 filed by the same applicant in 2008. The inventor of this application has proven that for a driver sitting on a conventional car seat, movement of the foot from the accelerator pedal to the brake pedal is not at all optimal. In other words, there exists a certain unnatural position of the pedal-controlling leg that can provide a more optimal braking condition, i.e., a condition that allows shortening of the braking time and hence of the braking path.

To provide the most optimal position of the driver's right leg in order to shorten the momentum for movement of a foot from the accelerator pedal to the brake pedal and to subsequently press the brake pedal, the inventor herein developed a special under-thigh support pillow that can be used for supporting and fixing the driver's right leg in the aforementioned optimal position. The aforementioned under-thigh support pillow is the subject of the aforementioned U.S. Pat. No. 7,255,396 and the pending U.S. patent application Ser. No. 12/011,316. Use of the aforementioned under-thigh support is justified only if the aforementioned under-thigh support is installed and fixed in a predetermined position that depends on specific anthropometric data of each individual driver. In other words, the most optimal position of the under-thigh support of the aforementioned patent application will vary for people of different builds.

Also it has been shown and proven that use of such under-thigh support, alone, improves blood circulation in the driver's leg due to redistribution of blood circulation provided by the specific shape of the support and due to the fact that the support raises the leg to a position in which the lower surface of the thigh is out of contact with the seat edge.

To prove this phenomenon, the inventor herein conducted a study that showed that use of the “Travel Pillow” mentioned in the above patent and patent applications increased blood flow in the lower extremity by 10 to 20%, thus decreasing the risk of stasis and subsequent clots to near zero.

However, the thigh supports known heretofore produced improved blood-circulation effect due to an indirect or passive action. Furthermore, none of the devices described above combines the function of improvement of blood circulation in legs with the function of shortening brake-activation time.

### OBJECTS AND SUMMARY OF THE INVENTION

It is an object of the present invention to provide a thigh support that combines the function of improvement of blood circulation in a user's leg with the function of shortening the brake activation time. It is another object to provide a thigh support of the aforementioned type that improves blood circulation by active means that physically affects the thigh tissue. It is a further object of the invention to provide a thigh support wherein the aforementioned means of physical influence on thigh tissue is a vibratory device. It is another object to provide a thigh support of the aforementioned type wherein vibrations are transmitted to thigh tissues through a closed volume of liquid. It is a further object to provide a thigh support of the aforementioned type that is self-inflatable and can be inflated, filled with a liquid and sealed for imparting predetermined rigidity to the support, deflated, freed from liquid, and folded for storing in a small-volume state. It is a specific object to provide a thigh support of the aforementioned type that shortens the brake activation time and at the same time improves blood circulation in the leg of a driver who remains immobile in the driver's seat over an extended period of time.

The thigh support of the invention consists of two main parts: a self-inflatable pad member snuggly fitted into a first compartment of the external casing and a vibration-transmission member snuggly fitted into a second compartment of the external casing. The outer casing is made from a strong and soft non-stretchable fabric. Both compartments are isolated from each other and allow independent insertion and removal of respective parts. The self-inflatable pad may have a triangular cross-section and a shape of the type disclosed in the pending U.S. patent applications Ser. No. 12/011,316. In other words, the self-inflatable pad is provided with a thin flexible pad casing made from air-proof fabric, the interior of which is filled with a plastic foam, e.g., polyurethane. The pad casing is provided with a valve, which, when opened, allows displacement of air from the air-proof casing and, when closed after self-inflation of the plastic foam, forms a resilient body of sufficient resiliency which can be adjusted by relieving air from the pad casing. The vibration-transmission member is made in the form of a sealed cartridge having a substantially flat shape and dimensions corresponding to one side of the triangular pad to which it is applied when inserted into the first compartment. The sealed cartridge has a case made from strong rubber. It is provided with a valve on the end-face side for filling the interior of the case with liquid, e.g., water, and a recess on the lateral side that faces the inflatable pad and contains a vibratory unit for transmission of vibrations to the thigh of the user through the liquid when it is used for supporting the user's thigh, e.g., a thigh of a driver during a lengthy trip. The vibratory-unit compartment has a sealed section located under the vibratory unit, which contains a battery cell electrically connected with terminal contacts of the vibratory unit. The latter may be comprised of an electric motor and a misbalanced eccentric mass that generates mechanical vibrations during rotation. According to one modification, the electric motor of the vibratory device is activated by pushing a start button that closes the power supply circuit from the battery cell to the electric motor. According to another modification, the thigh support may be alternatively or additionally provided with a socket for connection of the motor to the cigarette lighter of the vehicle.

In use, when the thigh support of the invention is placed under the thigh of the driver who remains in a seated position for many hours and is subject to the probability of blood-clot formation in the blood vessels and to the risk of incurring venous thrombosis, activation of the vibratory unit transmits acoustic vibrations to the driver's thigh tissue through the liquid and thus causes inflow of blood and improves blood circulation through the area of contact with the drivers body. Resiliency of the thigh support and provision of liquid therein result in good conformity to the area of contact, and the fact that liquid, e.g., water, is non-compressible and has the acoustic constant close to that of the human body, further contributes to the operational efficiency of the vibratory pad.

### BRIEF DESCRIPTION OF THE DRAWINGS

FIG. 1 is a general three-dimensional view of the thigh support of the invention.

FIG. 2 is a sectional view along line II-II of FIG. 1.

FIG. 3 is a three-dimensional view of a self-inflatable pad member insertable into one compartment of the thigh-support casing.

FIG. 4 is a longitudinal sectional view of the vibratory unit used in the present invention.

FIG. 5 is an electric circuit of the vibratory unit of the invention.

### DETAILED DESCRIPTION OF THE INVENTION

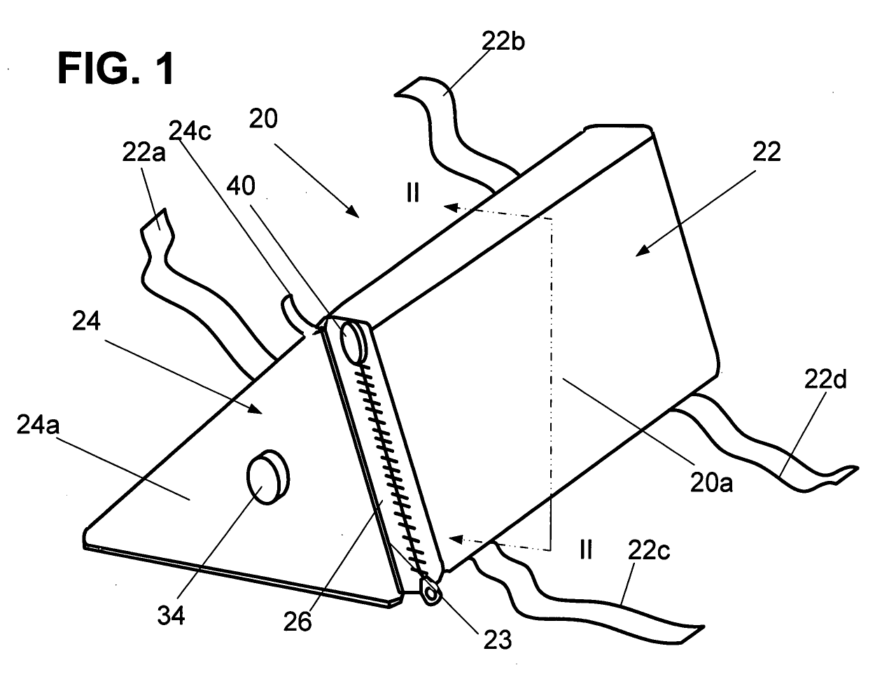

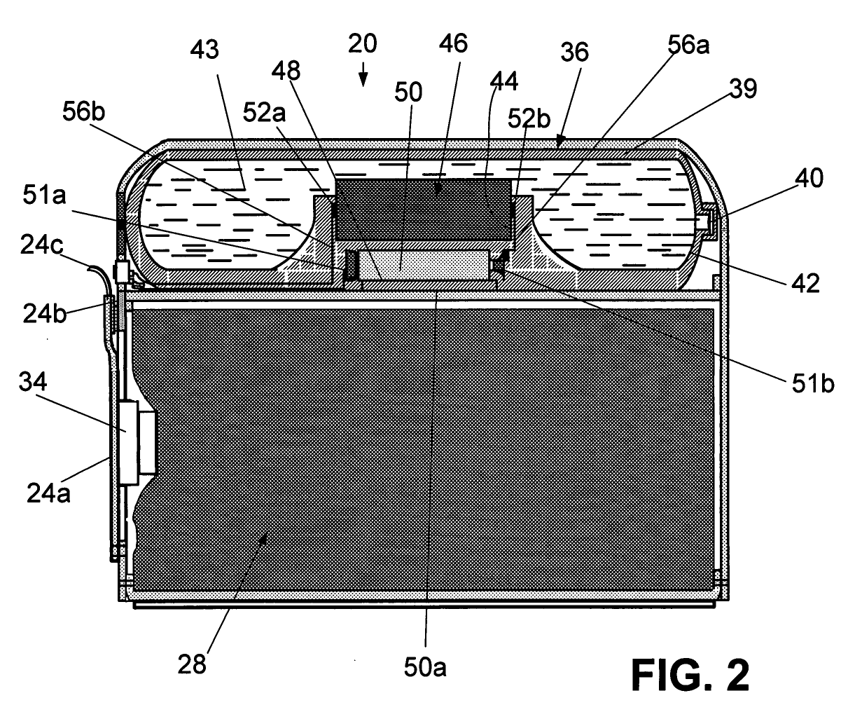

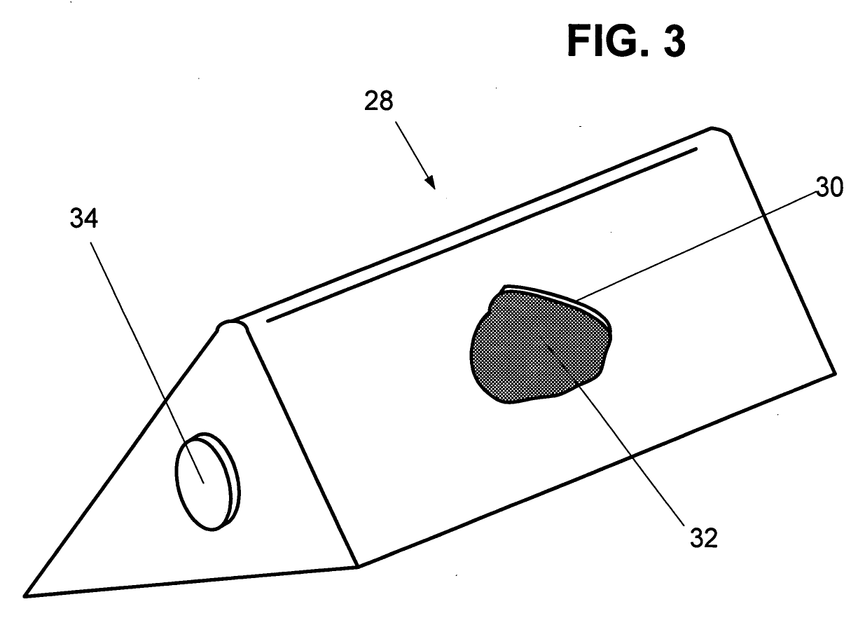

A general three-dimensional view of the thigh support of the invention is shown in FIG. 1. FIG. 2 is a sectional view along line II-II of FIG. 1. As can be seen from FIGS. 1 and 2, a thigh support, e.g., the brake-activation time-shortening thigh support 20 of the invention comprises an elongated body having a thigh support surface 20a and a triangular cross-section in a plane perpendicular to the thigh support surface 20a. The thigh support has an external casing 22 made from a strong and soft non-stretchable fabric with two compartments 24 and 26. The compartment 24 contains a thigh-support member in the form of a self-inflatable pad 28, a three-dimensional view of which is shown in FIG. 3. The self-inflatable pad member 28 can be the same as one disclosed in U.S. patent application Ser. No. 12/011,316 filed Jan. 26, 2008. The self-inflatable pad 28 is made in the form of an elongated body of a triangular cross-section that consists of an air-proof pad casing 30 (FIG. 2) made from a non-stretchable flexible material and a squeezable foam plastic 32 that fills the interior of the casing. The casing 30 is provided with a valve 34 that can be opened for opening access of the air-proof pad casing interior to the atmosphere and for squeezing the pad to a compressed state and then closed for preserving the pad 28 in a compressed state convenient for storage and transportation. For use of the pad, the valve 34 is opened, the squeezed foam plastic 32 is expanded, and then the valve 34 is closed, whereby the pad 28 is maintained in a predetermined shape and with a predetermined rigidity. The self-inflatable pad is inserted into the first compartment 24 in a squeezed state, and then the valve 34 is opened for self-expansion of the foam plastic, which is expended to the condition in which it snuggly fits into the first compartment 24 of the external casing 22. An end-face side 24a of the first compartment can be opened for providing access to the interior of the compartment 24 and can be closed and fixed to the end face 24b of the external casing 22, e.g., by a connection means 23 that comprises a combination of tiny hooks and tiny loops of the type known under trademark Velcro® and produced by FastenNation, Inc., NJ, USA. Reference numerals 22a, 22b, 22c, and 22d designate straps for attachment of the thigh support to the driver's seat (not shown). Reference numeral 24c (FIG. 2) designates a tab that is attached to the end face side 24a and can be used for opening the first compartment when the tab 24c is pulled away from the end face 24b of the external casing.

The second compartment 26 of the external casing 22 is intended for containing a vibration-transmission member 36 (FIG. 2) snuggly fitted into this compartment. The compartment 26 is provided with a zipper-type fastener 37 for closing or opening the compartment. Both compartments 24 and 26 are isolated from each other by a partition 38 (FIG. 2), which is a common wall between the compartments 24 and 26, and allows independent insertion and removal of respective parts. The vibration-transmission member 36 is made in the form of a sealed cartridge having a substantially flat shape and dimensions corresponding to the side of the triangular pad 28, which is adjacent to the vibration-transmission member 36 and is inserted into the first compartment 24 (FIG. 2). The vibration-transmission member 36 has a sealed case 39 made from a liquid-proof resilient material such as strong rubber. It is provided with a valve 40 on an end-face side 42 for filling the interior of the case with liquid 43, e.g., water, and a sealed recess 44 on the lateral side that faces the inflatable pad 28 and contains a vibratory unit 46 for transmission of vibrations to the thigh of the user through the liquid 43 when it is used for supporting the user's thigh, e.g., a thigh of a driver (not shown) during a long trip. Since location of the valve 40 is optional, in FIG. 2 the valve 40 is shown on the side opposite to the side where the valve is shown in FIG. 1. The vibratory-unit recess 44 (FIG. 2) has a sealed section 48 located under the vibratory unit 46, which contains a battery cell 50 (FIG. 2) with terminal contacts 51 a and 51 b electrically connected with respective terminal contacts 52a and 52b of the vibratory unit 46. Reference numeral 50a designates a cover of the sealed section 48 that contains the battery cell 50.

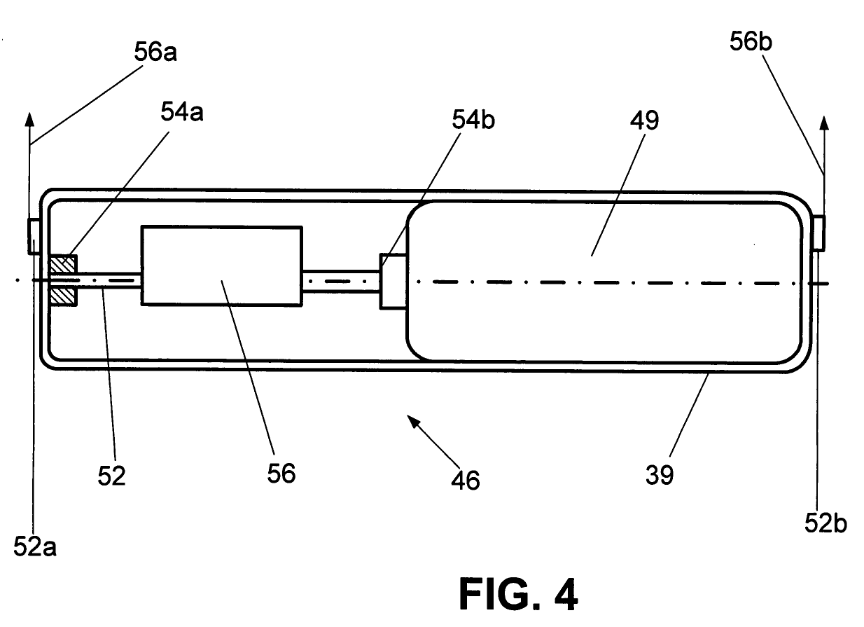

As shown in FIG. 4, the vibratory unit 46 may comprise a sealed casing, made, e.g., from strong rubber, that contains an electric motor 49 with an output shaft 52 rotatably supported by bearings 54a and 54b. Fixed to the output shaft 52 inside the sealed casing is a misbalanced eccentric mass 56 (FIG. 4) that generates mechanical vibrations during rotation. The terminal contacts 52a and 52b of the electric motor 49 are connected to the terminal contacts 51 a and 51 b of the battery cell by lead wires 56a and 56b (FIGS. 2 and 4). The small vibration motor, or micromotor, may also comprise a commercially produced product or may be of the type disclosed in U.S. Pat. No. 5,022,384 issued in 1991 to J. Freels, et al. The vibratory unit 46 vibrates as a whole since it is installed and supported in a resilient rubber case 39.

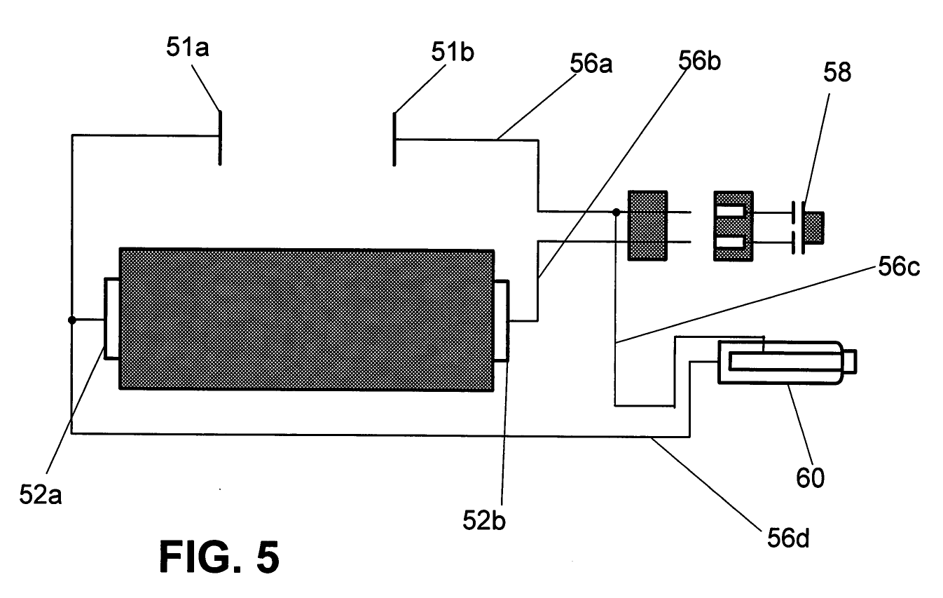

FIG. 5 illustrates a diagram of the thigh support 20 with the vibratory unit 46 for improved blood circulation. It can be seen that motor 49 (FIG. 4) of the vibratory unit 46 can be connected either to the 12V battery cell 50 through the lead wires 56a and 56b and energized under control of a pushbutton 58, or can be connected to the cigarette lighter of a vehicle (not shown) by means of a conventional cigarette-lighter adapter 60 through lead wires 56c and 56d connected in parallel to the battery, respectively.

If, prior to use, the thigh support 20 is stored for a long time in a deflated state and the battery cell 50 is exhausted, the user may remove the vibratory unit 46 from the second compartment 26, open the cover 50a, replace the battery cell 50, close the cover 50a, check the condition of the liquid 43 in the interior of the vibration-transmission member 36, if necessary, refill the cavity of the vibration-transmission member 36 with new liquid through the valve 40, and re-insert the vibratory unit 46 into the second compartment 26.

The user then opens the valve 34 and allows the foam plastic 32 to expand from the compressed condition due to its resiliency. While expanding, the foam plastic allows air to fill its interior cells, and after complete expansion to a condition in which the respective side of the self-expandable pad 28 tightly contacts the vibratory unit 46, the valve 34 is closed. The end-face side 24a of the first compartment is closed, and the thigh support 20 is ready for use.

First, the thigh support 20 is placed and fixed to the driver's seat, e.g., with the use of the straps 22a, 22b, 22c, and 22d, in a position that provides the shortest brake-activation time. This can be carried out by the method disclosed in U.S. patent application Ser. No. 11. The method consists of connecting the brake pedal and acceleration pedal to appropriate tilt sensors (not shown in the drawing of the present patent application), linking the sensors to a recording instrument and measuring the time of release of the driver's right foot from the acceleration pedal, the time of transfer of the foot to the brake pedal, and the time of pushing the brake pedal to the end of the stroke for different positions of the thigh support 20. The position that provides the shortest summarized time of all time components is selected as the most optimal, and the thigh support 20 is fixed at that position.

During long hours of driving, the driver activates the vibratory unit 46 (FIG. 2) by pushing the button 58 (FIG. 5). The vibratory unit 46 transmits acoustic vibrations to the driver's thigh tissue through the liquid 36 and thus causes inflow of blood and improves blood circulation through the area of contact with the driver's body. Resiliency of the thigh support and provision of liquid therein result in good conformity to the area of contact, and the fact that liquid, e.g., water, is non-compressible and has the acoustic constant close to that of the human body further contributes to the operational efficiency of the thigh support.

If necessary, the motor of the vibratory unit can be supplied by power from the cigarette-lighter socket of the vehicle through the cigarette-lighter adapter 60 (FIG. 5).

Thus, it has been shown that the present invention provides a thigh support that combines the function of improvement of blood circulation in a user's leg with the function of shortening brake activation time. The invention provides a thigh support of the aforementioned type that improves blood circulation by active vibratory means that physically affects the thigh tissue. Vibrations are transmitted to thigh tissue through a closed volume of liquid. The thigh support is self-inflatable and can be inflated, filled with a liquid and sealed for imparting predetermined rigidity to the support, deflated, freed from the liquid, and folded for storing in a small-volume state.

Although the invention has been shown and described with reference to specific embodiments, it is understood that these embodiments should not be construed as limiting the areas of application of the invention and that any changes and modifications are possible provided that these changes and modifications do not depart from the scope of the attached patent claims. For example, the vibratory unit may be of an electromagnetic type and driven from an electromagnetic vibrator. The entire device can be built into the vehicle seat with possibility of adjustment of its position across the seat. The device of the invention can be used only for the function of improved blood circulation and can be installed in a wheelchair, aircraft seat, armchair, or the like.

1. A thigh support with a vibratory device for improved blood circulation comprising:
an external casing having a first compartment, a second compartment, and a partition between compartments;
a thigh support member contained in the first compartment; and
a vibration-transmission member, which is contained in the second compartment in contact with the thigh support member through said compartment and intended for transmitting vibrations to the user's thigh in order to improve blood circulation conditions in the user's leg.

2. The thigh support of claim 1, wherein the thigh support member is a resilient pad.

3. The thigh support of claim 2, wherein the resilient pad is a self-inflatable pad.

4. The thigh support of claim 1, comprising means for attaching the thigh support to a driver's seat.

5. The thigh support of claim 1, wherein the vibration-transmission member comprises a sealed casing made from a liquid-proof resilient material and having a sealed recess; a liquid that fills the sealed casing; a vibratory unit inserted into said sealed recess for transmission of vibrations from the vibratory unit through the liquid to the user's thigh when the thigh support is placed under the user's thigh; s battery cell inserted into said sealed recess of the sealed casing; and electrical wiring that electrically connects the battery cell with the vibratory unit.

6. The thigh support of claim 5, wherein the vibratory unit comprises an electric motor that has an output shaft and receives power from the battery cell through the aforementioned electric wiring and a misbalanced eccentric mass supported by said output shaft inside the vibratory unit.

7. The thigh support of claim 6, wherein the electrical wiring contains a pushbutton that is electrically connected between the electric motor and the battery cell and that controls electrical connection of the electric battery to the electric motor.

8. The thigh support of claim 7, further comprising a vehicle cigarette-lighter adapter connectable to the electric motor when the electric motor is disconnected from the battery cell.

9. The thigh support of claim 3, wherein the self-inflatable pad has an air-proof pad casing having an interior filled with squeezable foam plastic and a valve for opening access of the air-proof pad casing interior to the atmosphere or for sealing the aforementioned interior when the valve is closed.

10. The thigh support of claim 9, wherein the vibration-transmission member comprises a sealed casing made from a liquid-proof resilient material and having a sealed recess; a liquid that fills the sealed casing; a vibratory unit inserted into said sealed recess for transmission of vibrations from the vibratory unit through the liquid to the user's thigh when the thigh support is placed under the user's thigh; a battery cell inserted into said sealed recess of the sealed casing; and electrical wiring that electrically connects the battery cell with the vibratory unit.

11. The thigh support of claim 10, wherein the sealed casing has a cap that can be opened for pouring the aforementioned liquid in or out.

12. The thigh support of claim 11, wherein the valve and the cap are located outside the external casing when the thigh support member is contained in the first compartment and when the vibration-transmission member is contained in the second compartment.

13. The thigh support of claim 1, wherein the thigh support member comprises an elongated body having a thigh support surface and a triangular cross-section in a plane perpendicular to the thigh support surface.

14. The thigh support of claim 13, wherein the vibration-transmission member has a substantially flat shape and dimensions corresponding to said support surface.

15. The thigh support of claim 14, wherein the thigh support member is a self-inflatable pad.

16. The thigh support of claim 14, comprising means for attachment of the brake-activation time-shortening thigh support to a driver's seat.

17. The thigh support of claim 14, wherein the vibration-transmission member comprises a sealed casing made from a liquid-proof resilient material and having a sealed recess; a liquid that fills the sealed casing; a vibratory unit inserted into said sealed recess for transmission of vibrations from the vibratory unit through the liquid to the user's thigh when the thigh support is placed under the user's thigh; a battery cell inserted into said sealed recess of the sealed casing; and electrical wiring that electrically connects the battery cell with the vibratory unit.

18. The thigh support of claim 17, wherein the vibratory unit comprises an electric motor that has an output shaft and receives power from the battery cell through the aforementioned electrical wiring and a misbalanced eccentric mass supported by said output shaft inside the vibratory unit.

19. The thigh support of claim 18, wherein the electrical wiring contains a pushbutton that is electrically connected between the electric motor and the battery cell and that controls electrical connection of the electric battery to the electric motor.

20. The thigh support of claim 19, further comprising a vehicle cigarette-lighter adapter connectable to the electric motor when the electric motor is disconnected from the battery cell.

21. The thigh support of claim 19, wherein the vibration-transmission member comprises a sealed casing made from a liquid-proof resilient material and having a sealed recess; a liquid that fills the sealed casing; a vibratory unit inserted into said sealed recess for transmission of vibrations from the vibratory unit through the liquid to the user's thigh when the thigh support is placed under the user's thigh; a battery cell inserted into said sealed recess of the sealed casing; and electrical wiring that electrically connects the battery cell with the vibratory unit.

22. The thigh support of claim 2, wherein the resilient pad is a brake-activation time-shortening resilient pad.

23. The thigh support of claim 22, wherein the brake-activation time-shortening resilient pad is a self-inflatable pad.

24. The thigh support of claim 22, wherein the vibration-transmission member comprises a sealed casing made from a liquid-proof resilient material and having a sealed recess; a liquid that fills the sealed casing; a vibratory unit inserted into said sealed recess for transmission of vibrations from the vibratory unit through the liquid to the user's thigh when the thigh support is placed under the user's thigh; a battery cell inserted into said sealed recess of the sealed casing; and electrical wiring that electrically connects the battery cell with the vibratory unit.

25. The thigh support of claim 23, wherein the vibration-transmission member comprises a sealed casing made from a liquid-proof resilient material and having a sealed recess; a liquid that fills the sealed casing; a vibratory unit inserted into said sealed recess for transmission of vibrations from the vibratory unit through the liquid to the user's thigh when the thigh support is placed under the user's thigh; a battery cell inserted into said sealed recess of the sealed casing; and electrical wiring that electrically connects the battery cell with the vibratory unit.
